(19) United States
(12) Patent Application Publication
(10) Pub. No.: US 2018/0186147 A1
(43) Pub. Date: Jul. 5, 2018

(54) Screen Printing Device and Method for Screen Printing

(71) Applicant: Thieme GmbH & Co. KG, Teningen (DE)

(72) Inventors: Elmar WINTERHALTER, Endingen (DE); Dietmar WEBER, Reute (DE); Ewald KOENIG, Wyhl (DE); Stefan HOLZER, Emmendingen (DE)

(21) Appl. No.: 15/741,045

(22) PCT Filed: Jun. 29, 2016
(86) PCT No.: PCT/EP2016/065151

§ 371 Date: Dec. 29, 2017

(30) Foreign Application Priority Data
Jul. 3, 2015 (DE) 10 2015 212 515.7

(51) Int. Cl. B41F 15/08; B41F 15/46

(52) U.S. Cl. CPC B41F 15/0818; B41F 15/46

(57) ABSTRACT

A screen printing device is provided having a printing screen, a printing squeegee and a support for printing material to be printed. At least one articulated arm robot is provided to move the printing squeegee and/or the support in relation to the printing screen.

### BACKGROUND AND SUMMARY OF THE INVENTION

The invention relates to a screen printing device having a printing screen, a printing squeegee and a support for printing material to be printed. The invention also relates to a method for screen printing with a screen printing device according to the invention.

A printing squeegee for printing curved surfaces is known from the international laid-open specification WO 2005/035250 A1. The printing squeegee has a holding section, to which the squeegee rubber is fixed, wherein the holding section comprises a plurality of individual sections which are connected to one another by means of the squeegee rubber and, as a result, are flexible. The squeegee rubber can be cut in accordance with the contour of the printing material to be printed.

The international laid-open specification WO 2005/035251 A1 discloses a screen printing device in which a top part is guided in slotted guides and, as a result, during a printing movement, the squeegee can be pivoted in relation to printing material to be printed. The slotted guides have to be matched to the curvature of the respective printing material to be printed. It is also known to arrange the top part pivotably with respect to a support for printing material to be printed by means of four adjusting cylinders. Via a control unit, the pivoting of the top part during the squeegee movement can then be adjusted in a manner matched to the curvature of the printing material to be printed.

The international laid-open specification WO 2013/068317 A1 discloses a screen printing squeegee which has a flexible holding section and a squeegee rubber connected to the holding section. The holding section comprises a plurality of individual sections connected elastically to one another. Several of the individual sections are connected to an adjusting cylinder, which in turn are fixed to a squeegee beam. By means of the adjusting cylinders, a profile of the squeegee rubber and of the holding section can be adjusted in a direction parallel to the squeegee beam, that is to say perpendicular to the direction of movement of the squeegee during printing.

A screen printing device and a method for screen printing are to be improved by the invention with regard to the flexibility during printing of curved printing material.

According to the invention, for this purpose a screen printing device having a printing screen, a printing squeegee and a support for printing material to be printed is provided, in which at least one articulated arm robot is provided to move the printing squeegee and/or the support in relation to the printing screen. By means of an articulated arm robot, the printing squeegee and/or the support can be guided in a freely programmable manner along the printing screen. As a result, curved printing material, in particular three-dimensionally curved printing material, can be printed highly precisely and the printing of differently curved printing material merely requires reprogramming of the movement sequence of the articulated arm robot. As a result, the screen printing device according to the invention can be used in an extremely flexible way. If the support is moved by means of the articulated arm robot, the movement of the support by means of the articulated arm robot must be carried out in synchronism with the movement of the printing squeegee. For example, the printing squeegee in a top part can be moved parallel to the printing screen by means of a squeegee beam. If, on the other hand, the printing squeegee is moved by means of the articulated arm robot, then the articulated arm robot with the printing squeegee follows the contour of the printing material to be printed. Provision is also made within the context of the invention that both the support and the printing squeegee are moved by means of an articulated arm robot each. Here too, the movement of the support and the movement of the printing squeegee must then be carried out in synchronism. The screen printing device according to the invention is also advantageous when printing flat printing material, since the movement path of the printing squeegee or else a flood squeegee can be chosen freely. For example, depending on application, diagonal squeegeeing or circular squeegeeing may be expedient or a flood squeegee is not moved linearly but such that the ink in the screen is kept at the desired points. The invention makes any desired movements of squeegees possible.

In a development of the invention, the articulated arm robot is constructed as a multi-axis robot, in particular a 5-axis robot or 6-axis robot.

In this way, sufficient degrees of freedom in the movement are available in order to be able to define the movement sequence of the printing squeegee and/or the support freely in space. In order to implement the screen printing device according to the invention, the articulated arm robot must have at least 3 axes.

In a development of the invention, the printing squeegee is connected to a movable robot hand of an articulated arm robot.

In this way, the contour of curved printing material to be printed can be followed without difficulty. For example, not only can the movement sequence of the printing squeegee be set optimally but also an angle of the printing squeegee in relation to the surface section of the printing material that is respectively currently touched can be set optimally. In this way, for example, it is possible to react to the different viscosity of printing inks or printing pastes in order to obtain an optimal printed result.

In a development of the invention, the support is connected to a movable robot hand of an articulated arm robot.

Given such a configuration, the support with the printing material to be printed and fixed thereto can be moved and pivoted in relation to the printing screen. This must be done in synchronism with a movement of the printing squeegee, the support in particular being pivoted such that a tangent to the surface sections currently in contact with the printing screen or the printing squeegee is always located parallel to the direction of movement of the printing squeegee. In this way, an optimal printed result can be ensured.

In a development of the invention, the printing squeegee is connected to a first articulated arm robot and the support is connected to a second articulated arm robot.

In this way, an extremely flexible screen printing device is provided, which can also be adapted to 3-dimensionally multiply curved printing materials.

In a development of the invention, a top part is provided having accommodation devices for the printing screen and having a squeegee beam that can be displaced along the top part and on which the printing squeegee is arranged, wherein the support is moved by means of the articulated arm robot in relation to the printing screen and in a manner coordinated with the movement of the printing squeegee.

In such a configuration, it is particularly advantageous that a conventional top part can be used which has mountings for printing screens and a drive for the squeegee beam to which the printing squeegee is fixed. Only the support for the printing material is held by means of an articulated arm robot, and the articulated arm robot moves the support with the printing material in synchronism with the squeegee movement, so that a respectively optimal angle and contact pressure between the printing squeegee, the printing screen and the printing material to be printed is present during the entire course of the printing operation.

In a development of the invention, a contact angle of the printing squeegee in relation to the contact surface of the printing material to be printed with the printing screen is kept within a predetermined angular range, in particular constant, during the movement of the printing squeegee, this being done by means of moving the support in relation to the printing screen.

In this way, the contact angle and also the contact pressure of the printing squeegee can be kept in an optimal range or at an optimal value.

In a development of the invention, a squeegee beam is arranged on the robot hand of the articulated arm robot, and the printing squeegee is connected to the squeegee beam by means of multiple adjusting cylinders.

Given such a configuration, the printing squeegee is guided by means of the articulated arm robot on a path which follows the contour of the printing material to be printed. As a result, a movement path of the printing squeegee that is optimal for printing the printing material can be set in a simple manner. Since an articulated arm robot is used to guide the printing squeegee, the movement path can be changed in any desired way in order to match the movement path to a changed contour of the printing material to be printed or, depending on the present boundary conditions, to obtain an optimal printed result.

In a development of the invention, the printing squeegee has a flexible holding section and a squeegee rubber fixed to the holding section, wherein a profile of the holding section and of the squeegee rubber can be varied by means of the adjusting cylinders.

A change in the profile in a direction parallel to the squeegee beam, that is to say at right angles to the movement of the printing squeegee, is expedient during the printing operation. As a result, the profile of the squeegee rubber can be matched to a contour of the printing material to be printed. By means of the articulated arm robot, the printing squeegee is guided here along a movement path which is matched to the curvature of the printing material in the printing direction. By means of the adjusting cylinders, the profile of the printing squeegee and of the squeegee rubber can be matched to a curvature of the printing material at right angles to the printing direction. As a result of these measures, particularly good printed results can be achieved when printing three-dimensionally curved printing material.

In a development of the invention, a flood squeegee is arranged on the robot hand of the articulated arm robot.

In addition, the movement of the flood squeegee, required before the actual printing operation in order to distribute printing ink or printing paste on the printing screen, can consequently be carried out by means of the articulated arm robot and, as a result, with a freely programmable movement path. It is entirely possible to provide for the movement path of the flood squeegee to differ from the movement path of the printing squeegee, different movement paths of printing squeegee and flood squeegee not being absolutely necessary and being set on the basis of the prevailing boundary conditions.

The problem on which the invention is based is also solved by a method for screen printing with a screen printing device according to the invention, wherein the movement of the printing squeegee and/or of the support by means of an articulated arm robot in relation to the printing screen during a printing operation are provided.

In a development of the invention, changing a squeegee pressure on the object to be printed and/or changing a squeegee angle in relation to the printing screen by means of the articulated arm robot during the movement of the printing squeegee relative to the printing screen is provided.

In a development of the invention, tilting the printing squeegee about an axis of rotation lying parallel to the direction of movement of the printing squeegee during the movement of the printing squeegee relative to the printing screen is provided.

By tilting the printing squeegee about an axis of rotation lying parallel to the direction of movement of the printing squeegee, the position of the printing squeegee can be matched to the curvature of the printing material currently to be printed. Such tilting movements of the printing squeegee are required in the case of complicatedly curved printing material in order to achieve an optimal printed result, and can be implemented without difficulty with the articulated arm robot of the screen printing device according to the invention.

In a development of the invention, learning a movement path of the printing squeegee and/or the support by means of moving to individual points and subsequently interpolating a movement path, and storing the movement path in a control unit of the at least one articulated arm robot is provided.

In this way, the required movement paths of the printing squeegee and/or of the support can be learned without difficulty. The learned movement paths can then be retrieved again in an un-problematical way via the control unit. As an alternative to learning movement paths, predefining movement paths generated in another way is also possible. For example, a required movement path can be generated in a CAD system, stored and transferred to the control unit of the at least one articulated arm robot.

In a development of the invention, learning and storing a squeegee angle, a squeegee pressure and settings for a flood system is provided.

In this way, all the settings and movement paths of the inventive screen printing device that are required for the optimal printing of curved printing material can be retrieved quickly and flexibly. These settings can, for example, also comprise a printing screen to be used and also a possible movement of the printing screen during the printing operation, what is known as a screen lift. If the screen printing device is then to be converted in order to print another printing material, the required settings can all be taken from the control unit, so that conversion can be carried out without difficulty and possibly even fully automatically.

Further features and advantages of the invention can be gathered from the claims and the following description of preferred embodiments of the invention in conjunction with the drawings. Individual features of the different embodiments shown in the drawings and described in the description can be combined with one another in any desired way without departing from the scope of the invention.

### BRIEF DESCRIPTION OF THE DRAWINGS

FIG. 1 shows a view of a screen printing device according to the invention according to a first embodiment, obliquely from below,

FIG. 2 shows the screen printing device of FIG. 1 in a first state during a printing operation,

FIG. 3 shows the screen printing device of FIG. 1 in a second state during a printing operation,

FIG. 4 shows the screen printing device of FIG. 1 in a third state during a printing operation,

FIG. 5 shows a screen printing device according to a second embodiment, obliquely from above,

FIG. 6 shows the screen printing device of FIG. 5 in a first state during a printing operation,

FIG. 7 shows the screen printing device of FIG. 5 in a second state during a printing operation,

FIG. 8 shows the screen printing device of FIG. 5 in a third state during a printing operation, and

FIG. 9 shows a screen printing device according to a third embodiment.

### DETAILED DESCRIPTION OF THE DRAWINGS

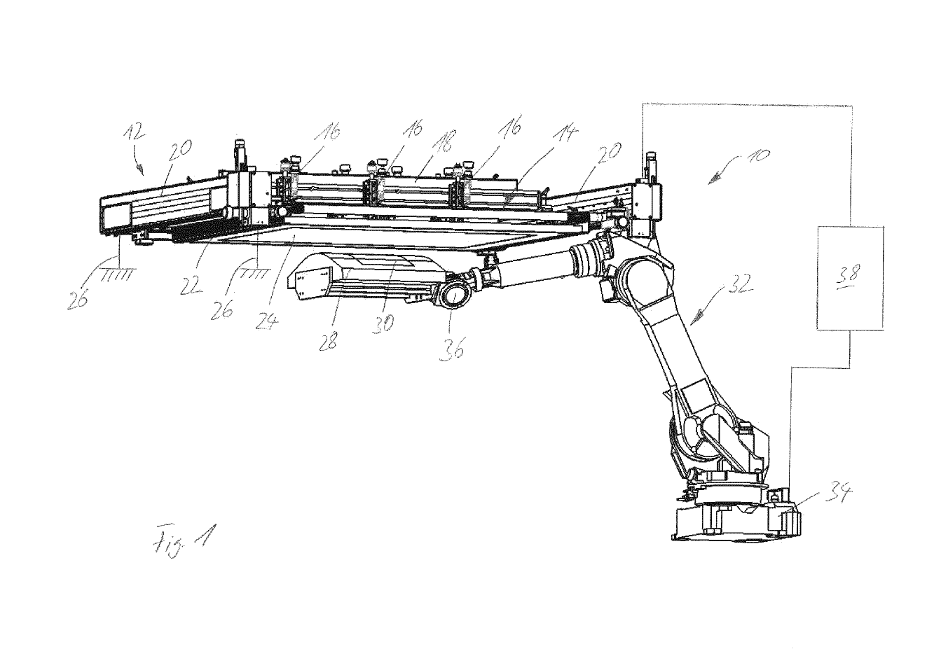

The illustration of FIG. 1 shows a screen printing device 10 according to a first embodiment of the invention. The screen printing device 10 has a top part 12 comprising a printing screen 14 and a printing squeegee 14, hidden in FIG. 1. The printing squeegee 14 is connected by means of three adjusting cylinders 16 to a squeegee beam 18, which is displaceably guided in two lateral guides 20 of the top part 12. The squeegee beam 18 can be moved to and fro along the guides 20 by means of drive devices, not illustrated.

Likewise arranged on the squeegee beam 18 is a flood squeegee, which cannot be seen in the illustration of FIG. 1. The flood squeegee is provided to uniformly distribute printing ink or printing paste applied to the printing screen 14 before the start of the actual printing operation.

The printing screen 14 is provided with a screen frame 22, which can be pivoted slightly in relation to the guides 20 and therefore in relation to the squeegee beam 18 having the printing squeegee 14. In this way, what is known as a screen lift can be achieved during the movement of the printing squeegee 14 over the printing screen 24. The top part 12 is connected to a base, for example a hall floor, by means of holding devices 26 merely indicated schematically. The guides 20 are thus arranged immovably in space during the printing operation but, of course, can be removed or moved for example for maintenance work or the like.

The screen printing device 10 also has a support 28 for printing material 30 to be printed. The printing material 30 is, for example, a one-dimensionally curved pane in FIG. 1. The pane or the printing material 30 lies on a suitably curved surface of the support 28, which is also designated as a mask. The support 28 is arranged underneath the printing screen 24, the printing material 30 not contacting the printing screen 24 in the state in FIG. 1. FIG. 1 thus shows a state still before the actual printing operation.

The screen printing device 10 is also provided with an articulated arm robot 32, which is fixed by its base 34, for example on a hall floor. The support 28 is fixed to a robot hand 36 of the articulated arm robot 32. The support 28 can thus be moved as desired in space and, specifically, any desired movement path in space can be executed with the support 28.

The articulated arm robot 32 in the embodiment illustrated is constructed as a 6-axis robot. By means of the articulated arm robot 32, it is possible to move the support 28 in a coordinated way along the guides 20 during the movement of the printing squeegee 14, so that the printing material 30 is synchronised with the movement of the printing squeegee 14. The support 28 is rotated here such that the printing squeegee 14 or the printing screen 24 each contacts only an approximately linear section of the printing material 30. With progressive squeegee movement, the support 28 or the printing material 30 then rolls on the printing screen 24, so that it is always possible for an optimal angle to be set between the printing material 30, the printing screen 24 and the printing squeegee 14.

The movement executed here by the support 28 is freely programmable in space. The embodiment illustrated, with one-dimensionally curved printing material 30, constitutes an application that is comparatively simple to achieve. By using the screen printing device 10 according to the invention, however, it is also possible to achieve optimal results when the printing material is curved in several directions, for example. Nevertheless, a movement path of the support 28 that is optimal for printing during the movement of the printing squeegee 14 can then be set by using the articulated arm robot 32.

Illustrated merely schematically in FIG. 1 is a central control unit 38, via which both the articulated arm robot 32 and the top part 12 can be driven. A movement path that is optimal for the printing material 30 is stored in the control unit 38 and, furthermore, the setting parameters of the top part 12 can also be stored, for example squeegee angle, contact pressure, screen lift, speed of movement of the printing squeegee 14, amount of ink to be applied and the like. When changing to printing material that is shaped differently from the printing material 30, it is necessary for only the support 28 to be changed, and settings stored in the control unit 38, including movement paths, for the new printing material are transferred to the articulated arm robot 32 and the top part 12, in order to permit rapid conversion to the new printing material.

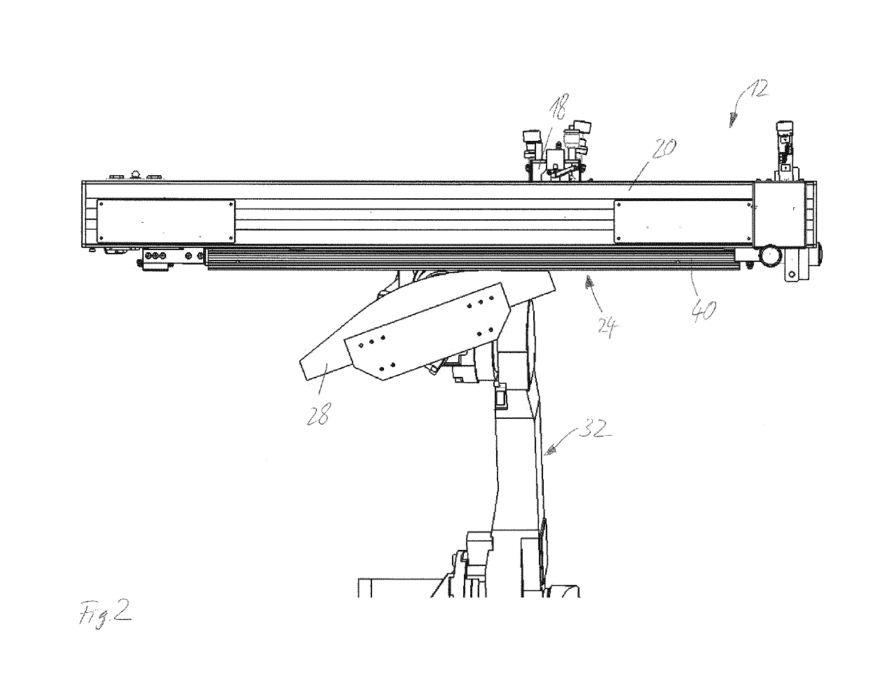

The illustrations of FIGS. 2, 3 and 4 show a section of the screen printing device 10 of FIG. 1 in various states during a printing operation.

In FIG. 2, a section of the articulated arm robot 32 can be seen. By means of the articulated arm robot 32, the support 28 and thus also the printing material, which cannot be seen in FIG. 2, has been arranged in a tilted position, tilted downward to the left in FIG. 2. Furthermore, the support 28 is arranged such that the printing material is arranged immediately underneath the printing screen 14, which cannot be seen in FIG. 2. In FIG. 2 it is possible to see only a screen frame 40, which is held on the top part 12 and on which the printing screen 14 is arranged. The squeegee beam 18 having the printing squeegee is located in a first state at the start of a movement from left to right along the guides 20. The printing squeegee 18 in the state illustrated is arranged at an end of the printing material located on the right in FIG. 2. By means of the printing squeegee, the printing screen in the region of the printing position is brought into contact with the printing material. During the progressive movement of the squeegee beam 18 to the left, starting from the state of FIG. 2, with the printing squeegee arranged thereon, the printing squeegee sweeps over the printing screen and forces ink through openings in the printing screen 14 onto the printing material on the support 28.

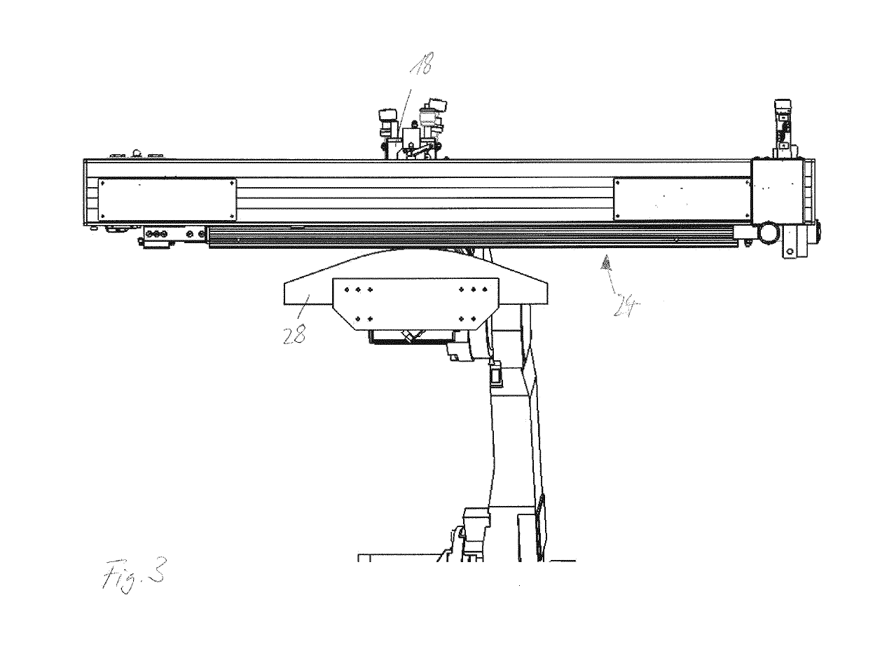

With progressive movement of the squeegee beam 18 to the left in FIG. 2, the second state, illustrated in FIG. 3, is reached during the printing operation. The support 28 has now been pivoted in the clockwise direction, starting from the state of FIG. 2, synchronously with the movement of the squeegee beam 18 with the printing squeegee fixed thereto. In other words, the surface of the support 28 facing the printing screen 14 has been rolled on the printing screen 14 in such a way that the printing squeegee is always arranged at the highest point of the printing material on the support 28. In other words, the support 28 is pivoted such that a tangent to the contact line between the printing squeegee and the printing material 30 always lies parallel to the direction of movement of the printing squeegee. The direction of movement of the printing squeegee is from right to left in FIGS. 2 to 4.

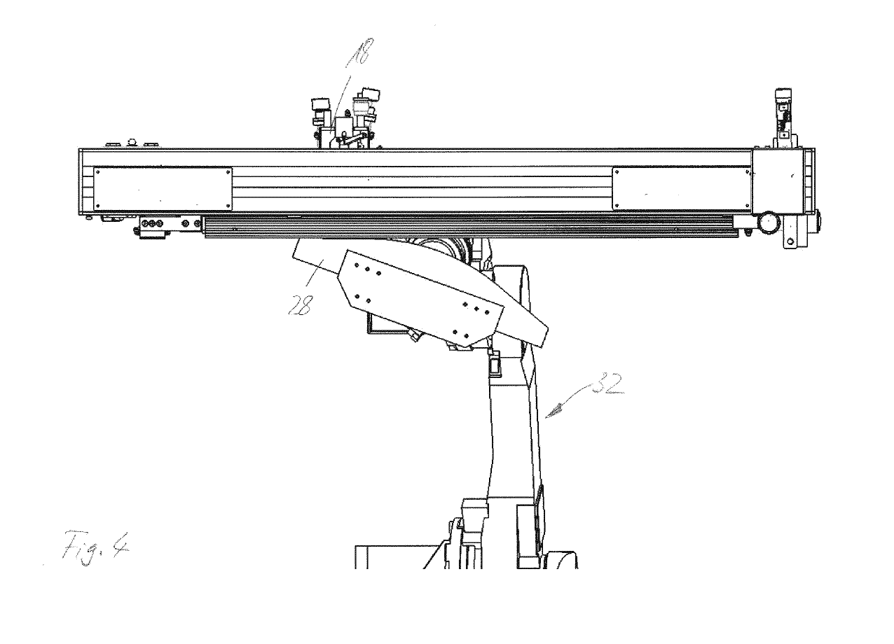

FIG. 4 shows a third state during the printing operation. The squeegee beam 18 with the printing squeegee has now moved so far to the left that it has reached the left-hand end of the printing material on the support 28. The support 28 has been pivoted further in the clockwise direction, starting from the state of FIG. 3.

By using FIGS. 2 to 4, it is easy to see that the movement of the support 28 is carried out in synchronism with the movement of the printing squeegee. By using the articulated robot 32, any desired movement paths of the support 28 or the printing material on the support 28 can be generated.

Programming the articulated arm robot 32 can either be carried out by importing data which, for example, has been generated by means of a CAD system. However, programming can also be carried out by means of a so-called learning operation. For example, the states illustrated in FIGS. 2, 3 and 4 are moved to and stored. The control unit 38 then performs an interpolation between the individual points on the movement path and then stores the movement path.

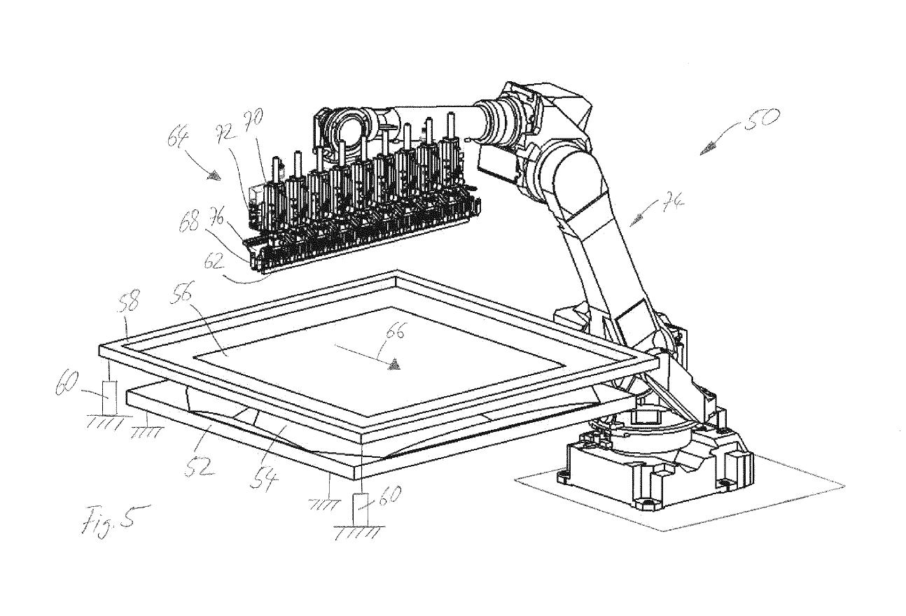

The illustration of FIG. 5 shows a second embodiment of a screen printing device 50 according to the invention. In the screen printing device 50, a support 52 for a 2-dimensionally curved printing material 54 is firmly connected to a base, for example a hall floor, which is indicated merely schematically in FIG. 5. Above the support 52, a printing screen 56 is fixed to a screen frame 58. The screen frame 58 is connected to the hall floor or another base by means of adjusting cylinders 60, merely indicated schematically. A total of four adjusting cylinders 60 are provided at the corners of the screen frame 58, only two being illustrated in FIG. 5 for clarity. The adjusting cylinders 60 are provided to raise the screen frame 58 with the printing screen 56 slightly if necessary in order, for example, to achieve a screen lift during the printing operation. As a rule, the adjusting cylinders 60 are not provided to preload the printing screen 56 in the direction of the printing material 54, in order to match the printing screen to the contour of the printing material 54 as a result. During the printing operation, the printing screen 56 is in contact with the printing material 54 only in the region where it is pressed onto the printing material 54 by a squeegee rubber 62 of a printing squeegee 64. The screen fabric of the printing screen 56 is sufficiently elastic to be pressed onto the printing material 54 to be printed by the printing squeegee 64 during the printing operation. Alternatively, curved screens can also be used, in which the screen frame and the screen fabric are curved in accordance with the printing material contour. The printing squeegee 64 is fixed to the robot hand of the articulated arm robot 50 and, by means of the articulated arm robot 50, is moved along a movement path which substantially follows the contour of the printing material 54 in the printing direction. The printing direction in the illustration of FIG. 5 runs along the arrow 66, that is to say from top left to bottom right.

Since the printing material 54 is curved two-dimensionally, that is to say also has a curved contour in a direction at right angles to the printing direction 66, the printing squeegee 64 is formed as a flexible printing squeegee. Specifically, the squeegee rubber 62 is held in a flexible holding section 68. The holding section 68, together with the squeegee rubber 62, can assume a curved profile in a direction at right angles to the printing direction 66 as a result. On the other hand, the holding section 68 is formed comparatively stiffly in and counter to the printing direction 66. The holding section 68 is connected to the squeegee beam 72 by a total of nine adjusting cylinders 70. By means of the adjusting cylinders 70, a desired curved profile of the squeegee rubber 62, which is matched to the curvature of the printing material 54 at right angles to the printing direction 66, can be set. A curvature of the squeegee rubber 62 can be adjusted during the movement of the printing squeegee 64 in the printing direction 66, in order as a result to achieve matching to a possibly changing curvature of the printing material 54. The movement path of the printing squeegee 64 is matched by means of the articulated arm robot 50 to a curvature of the printing material 54 parallel to the printing direction 66. As a result, by using the screen printing device 50 according to the invention, substantially any arbitrarily curved printing materials 54 can be printed.

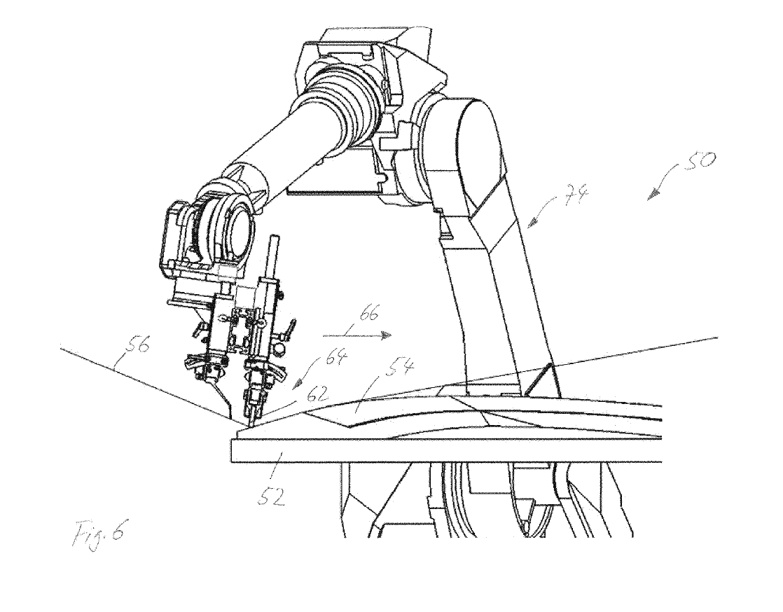

The illustration of FIG. 6 shows a section of the screen printing device 50 in a first state at the start of a printing operation. The printing screen 56 is illustrated schematically, and the squeegee rubber 62 of the printing squeegee 64 presses the printing screen 56 onto the curved support 52 and onto the printing material 54. The printing screen 56 is elastic, in order to participate in this extension. It can be gathered from FIG. 6 that the squeegee rubber 62 rests only on the printing screen 56 with its edge located at the front in the printing direction 66, and indirectly on the printing material 54. The printing squeegee 64 is thus always set slightly obliquely in relation to the printing material 54. A corresponding angle is maintained by means of the articulated arm robot 72 during the entire movement of the printing squeegee 64 over the printing material 54 to be printed.

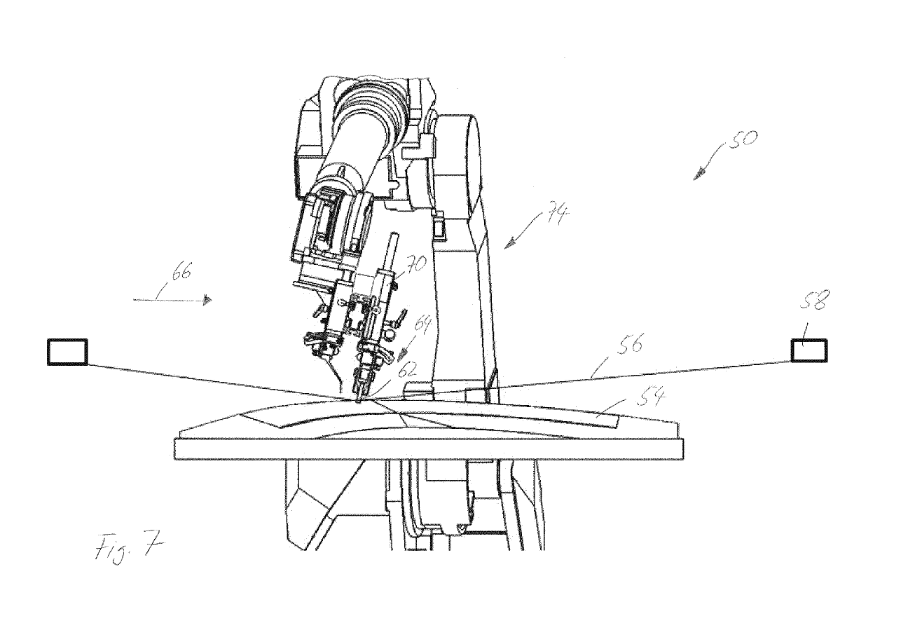

The illustration of FIG. 7 shows the screen printing device 50 in a second state during the printing operation. The printing squeegee 64 has now been moved by means of the articulated arm robot 72 further in the printing direction over the printing material 54 to be printed, for example a curved motor vehicle pane, the articulated arm robot 72 following the curvature of the printing material 54 in the printing direction 66. At the same time, as has been explained, a curvature of the squeegee rubber 62 at right angles to the printing direction 66 is matched to the curvature of the printing material 54 by means of the adjusting cylinders 70. It can be seen in FIG. 7 that the curvature of the printing material 54 changes both in the printing direction 66 and at right angles thereto. The screen printing device 50 according to the invention nevertheless permits optimal contact of the squeegee rubber 62 with the printing screen, not illustrated, and indirectly with the printing material 54 during the entire printing operation.

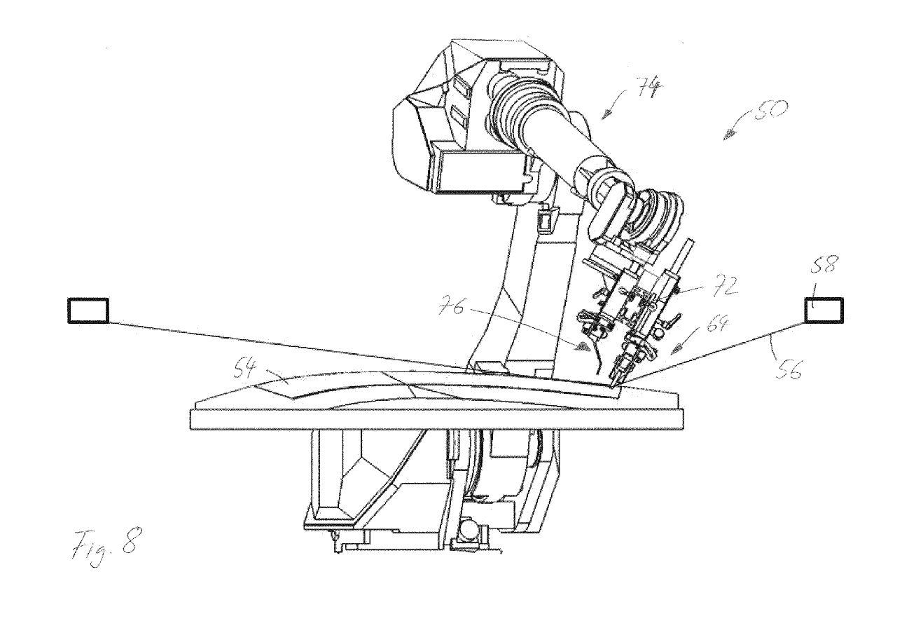

FIG. 8 shows a third state of the screen printing device 50 according to the invention shortly before completing the printing operation. The articulated arm robot 72 has now moved the printing squeegee 64 until shortly before the end of the printing material 54 on the right in FIG. 8. The printing operation is thus virtually completed.

As can be gathered further from FIGS. 5 to 8, a flood squeegee 76 is also arranged on the squeegee beam 72, beside the printing squeegee 64. The flood squeegee 76 serves to distribute printing ink or printing paste uniformly over the printing screen before the actual printing operation. The flood squeegee 76 can likewise be moved by means of the articulated arm robot 74 in any desired movement path in relation to the printing screen 56 that is freely definable in space. For example, the flooding with the flood squeegee 76 is carried out in the flat state of the printing screen 56 illustrated in FIG. 5. The articulated arm robot 74 guides the flood squeegee 76 rectilinearly and parallel to the printing screen 56. During the actual printing operation, the printing squeegee 64, as has been described, is then moved over the printing material 54, following the curvature of the latter.

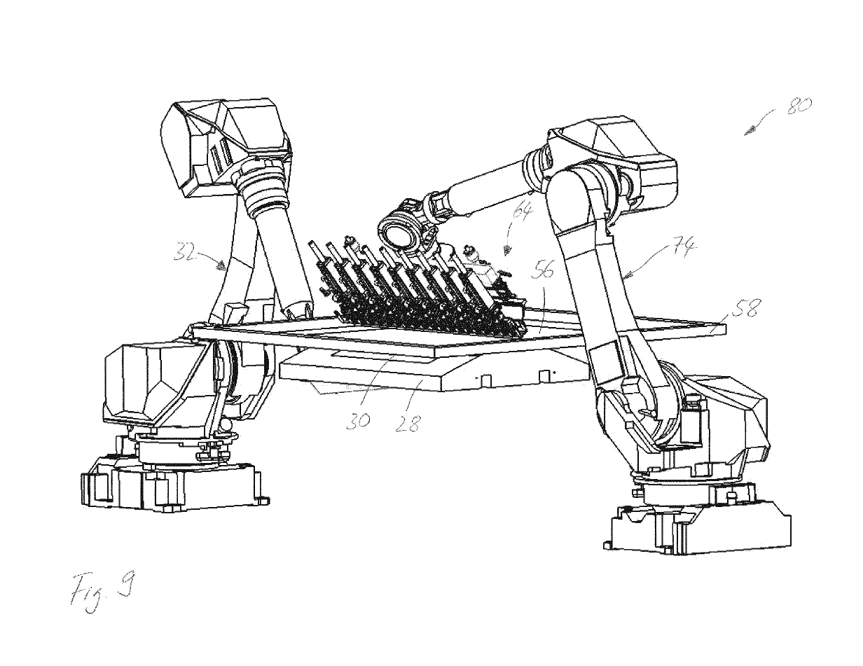

The illustration of FIG. 9 shows a screen printing device 80 according to the invention according to a further embodiment of the invention. The screen printing device 80 constitutes a combination of the screen printing devices 10 of FIGS. 1 to 4 and the screen printing device 50 of FIGS. 5 to 8. Identically constructed components will therefore not be explained.

In the screen printing device 80, the curved printing material 30 is fixed to the support 28 and, just as in the screen printing device 10, the support 28 is moved over the printing screen 56 in synchronism with the movement of the printing squeegee 64 by means of the articulated arm robot 32. The printing squeegee 64, just as in the screen printing device 50, is fixed to the robot hand of the articulated arm robot 74. The two articulated arm robots 32, 74 execute coordinated movements of the support 28 and of the printing squeegee 64 in order to print the printing material 30 optimally. The printing screen 56 with the screen frame 58 is arranged as in the screen printing device 50. In principle, the screen frame 58 is thus fixed in space; the screen frame 58 can be raised slightly during the printing operation only to achieve what is known as a screen lift, as has already been explained by using the screen printing device 50.

The screen printing device 80 permits extremely flexible use for an extremely wide range of printing materials. Both the movement of the support 28 and the movement of the printing squeegee 64 and of the flood squeegee 76 are freely programmable and, as a result, can be matched optimally to the respective application.

1.-14. (canceled)

15. A screen printing device, comprising:
a printing screen;
a printing squeegee;
a support for printing material to be printed;
at least one articulated arm robot provided to move the printing squeegee and/or the support in relation to the printing screen.

16. The screen printing device as claimed in claim 15, wherein
the articulated arm robot is constructed as a multi-axis robot.

17. The screen printing device as claimed in claim 15, wherein
the printing squeegee is connected to a movable robot hand of the articulated arm robot.

18. The screen printing device as claimed in claim 15, wherein
the support is connected to a movable robot hand of the articulated arm robot.

19. The screen printing device as claimed in claim 17, wherein
the support is connected to a movable robot hand of the articulated arm robot.

20. The screen printing device as claimed in claim 15, wherein
the printing squeegee is connected to a first articulated arm robot, and the support is connected to a second articulated arm robot.

21. The screen printing device as claimed in claim 15, further comprising:
a top part having accommodation devices for the printing screen and having a squeegee beam that is displaceable along the top part and on which the printing squeegee is arranged, wherein
the support is moved by the articulated arm robot in relation to the printing screen and in a manner coordinated with the movement of the printing squeegee.

22. The screen printing device as claimed in claim 21, wherein
a contact angle of the printing squeegee in relation to the contact surface of the printing material to be printed with the printing screen is kept within a predetermined angular range, during the movement of the printing squeegee, by moving the support in relation to the printing screen.

23. The screen printing device as claimed in claim 22, wherein
the angular range is constant.

24. The screen printing device as claimed in claim 15, further comprising:
a squeegee beam arranged on a robot hand of the articulated arm robot, wherein
the printing squeegee is connected to the squeegee beam by multiple adjusting cylinders.

25. The screen printing device as claimed in claim 24, wherein
the printing squeegee has a flexible holding section and a squeegee rubber fixed to the holding section, and
a profile of the holding section and of the squeegee rubber is variable by the multiple adjusting cylinders.

26. The screen printing device as claimed in claim 24, further comprising:
a flood squeegee arranged on the robot hand of the articulated arm robot.

27. The screen printing device as claimed in claim 25, further comprising:
a flood squeegee arranged on the robot hand of the articulated arm robot.

28. The screen printing device as claimed in claim 16, wherein
the multi-axis robot is a 5-axis or 6-axis robot.

29. A method for screen printing with a screen printing device comprising a printing screen, a printing squeegee, a support for printing material to be printed, and at least one articulated arm robot provided to move the printing squeegee and/or the support in relation to the printing screen, the method comprising the steps of:
moving the printing squeegee and/or the support in relation to the printing screen during a printing operation, wherein
the moving is carried out by the articulated arm robot.

30. The method as claimed in claim 29, further comprising the step of:
changing a squeegee pressure on the printing material to be printed and/or a squeegee angle in relation to the printing screen by the articulated arm robot during the movement of the printing squeegee relative to the printing screen.

31. The method as claimed in claim 30, further comprising the step of:
tilting the printing squeegee about an axis of rotation lying parallel to the direction of movement of the printing squeegee during the movement of the printing squeegee relative to the printing screen.

32. The method as claimed in claim 31, further comprising the step of:
learning and storing a squeegee angle, a squeegee pressure and settings for a flood system.
